(19) United States
(12) Patent Application Publication
(10) Pub. No.: US 2017/0080326 A1
(43) Pub. Date: Mar. 23, 2017

(54) METHODS, DEVICES AND SYSTEMS FOR PLAYING AND PRESENTING GAMES

(71) Applicants: Yuliya Kisselyova, Las Vegas, NV (US); Sean Henn, Henderson, NV (US)

(72) Inventors: Yuliya Kisselyova, Las Vegas, NV (US); Sean Henn, Henderson, NV (US)

(21) Appl. No.: 14/861,947

(22) Filed: Sep. 22, 2015

(51) Int. Cl. A63F 1/00; G07F 17/32

(52) U.S. Cl. CPC A63F 1/00; G07F 17/3251; G07F 17/3211; A63F 2001/005

(57) ABSTRACT

In a method of playing a card game, such as using physical cards at a gaming table or at an electronically controlled gaming machine, a player is dealt one or more original hole cards. The player may elect to retain the original hole cards or switch or replace them. Additional cards are dealt, such as flop and turn cards dealt as community cards. A player's final hand, such as a five card poker hand, is compared to a dealer or house hand to determine the outcome of the game. The player may be required to place an ante wager and a switch bet to play the game and may place or be required to place additional wagers along the course of the game. The player loses their switch wager if they elect to switch their hole cards.

### FIELD OF THE INVENTION

The present invention relates to methods of presenting and playing games and gaming machines and other devices configured to present games.

### BACKGROUND OF THE INVENTION

A variety of games are known, including various styles of wagering games. However, game players continue to seek new and exciting games. Game players particular like games which have been modified to make them more exciting or more favorable to them as those games have the advantage that the player does not need to learn to play an entirely new game, but has the familiarity of an old game.

The present invention comprises new methods, devices and systems for playing and presenting games.

### SUMMARY OF THE INVENTION

Embodiments of the invention comprise methods of playing and presenting games and gaming devices and system for presenting games.

One embodiment of the invention is a poker style game in which a player is dealt one or more initial cards and has the opportunity to switch those cards for replacement cards.

One embodiment of the invention comprises a method of playing/presenting a game comprising the step of:

receiving an ante wager from a player;

receiving a switch bet from said player;

dealing one or more original hole cards to the player;

receiving an election from the player whether to switch the one or more hole cards, wherein if the player elects, dealing a replacement hole card to the player for each original hole card, each replacement hole card and collecting the player's switch bet;

dealing one or more flop cards and one or more turn cards, the one or more flop cards;

receiving one or more additional wagers from the player;

determining an outcome of the game by comparing a dealer hand to a final player hand formed from the player's one or more replacement or hole cards and the one or more flop cards and the one or more turn cards; and

if the outcome of the game is a dealer hand win, collecting the player's ante wager, any additional wagers and the switch bet if not already collected and if the outcome of the game is a player hand win, awarding the player winnings and, if the player's switch bet was not collected, returning the switch bet to the player.

In one embodiment, a game of the invention may be presented at a game table or game board. The table may define a dealer area and one or more player areas. The player area(s) may define areas for an ante wager, the switch bet, additional wagers and the player hole cards. The game may be played using one or more sets or decks of physical playing cards, such as decks of standard 52 playing cards.

In another embodiment, a game of the invention may be presented at a gaming machine. The gaming machine may include a wagering accepting device, at least one game display, and a processor which is configured to cause the at least one game display to display game information such as images of dealt cards.

In one embodiment, the game is a played as a poker type game in which the dealer and each player are dealt two hole cards and then two flop cards and three turn cards are dealt as community cards. The player and dealer form their best five card poker hand from their hole cards and the five community cards.

Further objects, features, and advantages of the present invention over the prior art will become apparent from the detailed description of the drawings which follows, when considered with the attached figures.

### DESCRIPTION OF THE DRAWINGS

FIG. 1 is a flow diagram illustrating one embodiment of a method of the invention;

FIG. 2 illustrates one embodiment of a game table at which a game of the invention may be presented and played; and

FIG. 3 illustrates one embodiment of a gaming machine at which a game of the invention may be presented and played.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise methods of playing and presenting games. In one embodiment, a game of the invention comprises a poker type game using player cards and community cards, where the player has the opportunity switch or replace their player cards.

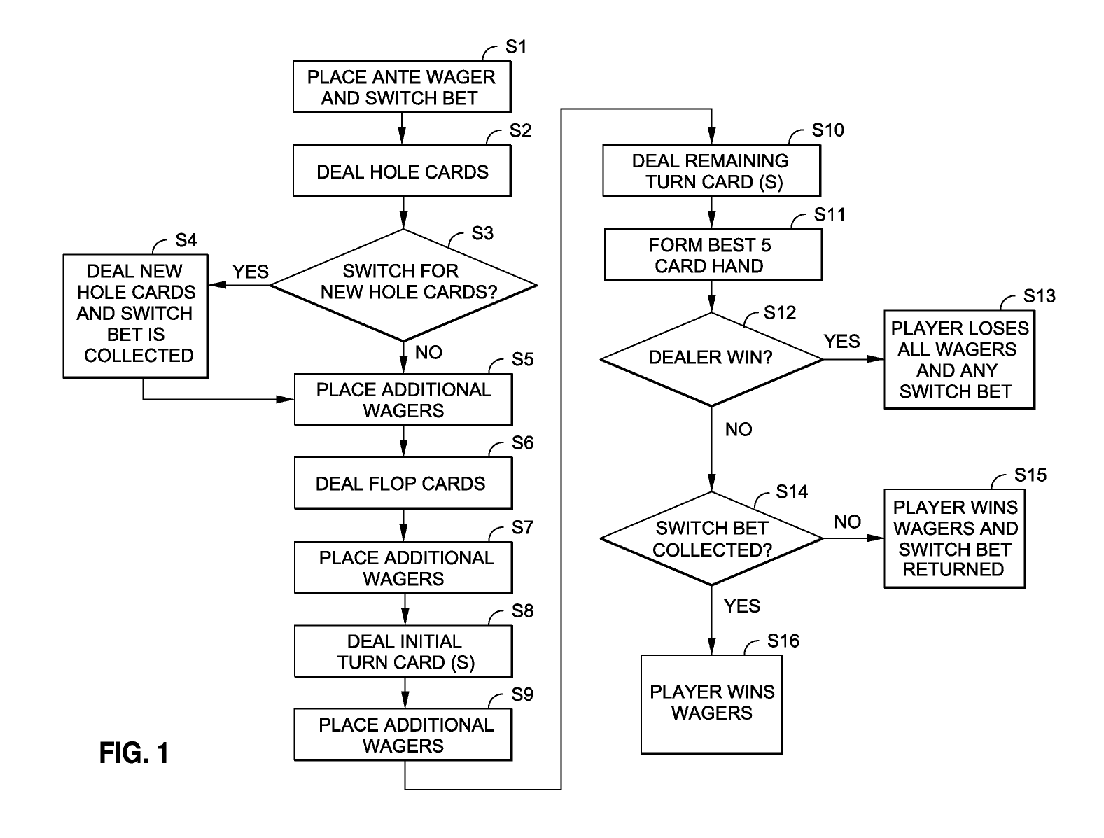

One embodiment of a method of playing and presenting a game will be described with reference to FIG. 1. In a first step S1, a player places an ante wager and a switch bet. The amount of the ante wager and switch bet may vary. In one embodiment, the ante wager and the switch bet are required to be the same amount, such as $1, $5, etc.

In a step S2, one or more original hole cards are dealt. In one embodiment, the game is played by a dealer (or the house) and at least one player. Preferably, two original hole cards are dealt to each player and the dealer.

In a step S3, it is determined whether the player wishes to switch or replace their original hole cards. This might be via an input or signal from the player.

If in step S3 the player has elected to switch their original hole cards, then in a step S4 the player is dealt a replacement hole card for each original hole card and the player's switch bet is collected or lost.

Thereafter, or if the player did not elect to switch their original hole cards in step S3, in a step S5 the player is allowed to place one or more additional wagers. In one embodiment, the player may check or place a first additional wager. In one embodiment, the additional wager may be 1 or 2 times the player's ante wager.

In a step S6, one or more flop cards are dealt. In one embodiment, two flop cards are dealt as community cards, e.g. usable by all players to the game as well as the dealer.

In a step S7, the player may again place one or more additional wagers. In one embodiment, the player may check or place a second additional wager. In one embodiment, the second additional wager may be 1 or 2 times the player's ante wager.

In a step S8, one or more initial turn cards are dealt. In one embodiment, a single turn card is dealt as a community card, e.g. usable by all players of the game as well as the dealer.

In a step S9, the player may again place one or more additional wagers. In one embodiment, the player must either place a third additional wager of 1 times their ante wager or they must fold. If the player folds, they lose the game and all of their wagers and their switch bet, if not already collected, is collected or lost.

If the player elects to wager the third additional wager, then in a step S10, one or more final turn cards are dealt. In one embodiment, two turn cards are dealt as community cards, e.g. usable by all players to the game as well as the dealer.

In a step S11, each remaining player and the dealer forms their best hand from their hole cards (in the case of the player, either their original hole cards or the replacement hole cards) and the community cards. In a preferred embodiment, this comprises the player and the dealer forming the best five card poker hand from their two hole cards and the five community cards (the two flop cards and three turn cards). Preferably each player and the dealer form the best five card poker hand based upon traditional poker hand rankings (e.g. the hands of high card, pair, two pair, three of a kind, full house, four of a kind, flush, straight, straight flush and royal flush, with the hands of the same type ranked based upon high card values or ranks).

In a step S12 it is determined whether the dealer has won or lost relative to each player. This is determined by a comparison of the dealer's hand to each player's final hand, using a predetermined ranking. In a preferred embodiment, the ranking is based upon traditional poker rules.

If it is determined that the dealer won, then in a step S13, the player loses the game, including their wager(s). Thus, the dealer or house collects the player's wagers, including their switch bet if it was not already collected.

If the player's hand beat the dealer's hand, then it is determined in a step S14 whether the player's switch bet was already collected. If not, then in a step S15, the player wins their wager(s) and the player's switch bet is returned. In a preferred embodiment a player is awarded winnings for winning wager(s). In one embodiment the winnings are paid at a rate of 1:1, e.g. the player retains their wager(s) and is paid an equal amount. Thus, if a player wagered $100, the player's $100 would be returned and the player would be awarded $100 in winnings.

If in step S14 it is determined that the player's switch bet was already collected, then the player simply wins their wager(s). Again, in a preferred embodiment, a player is awarded winnings at a rate of 1:1 of their wager(s).

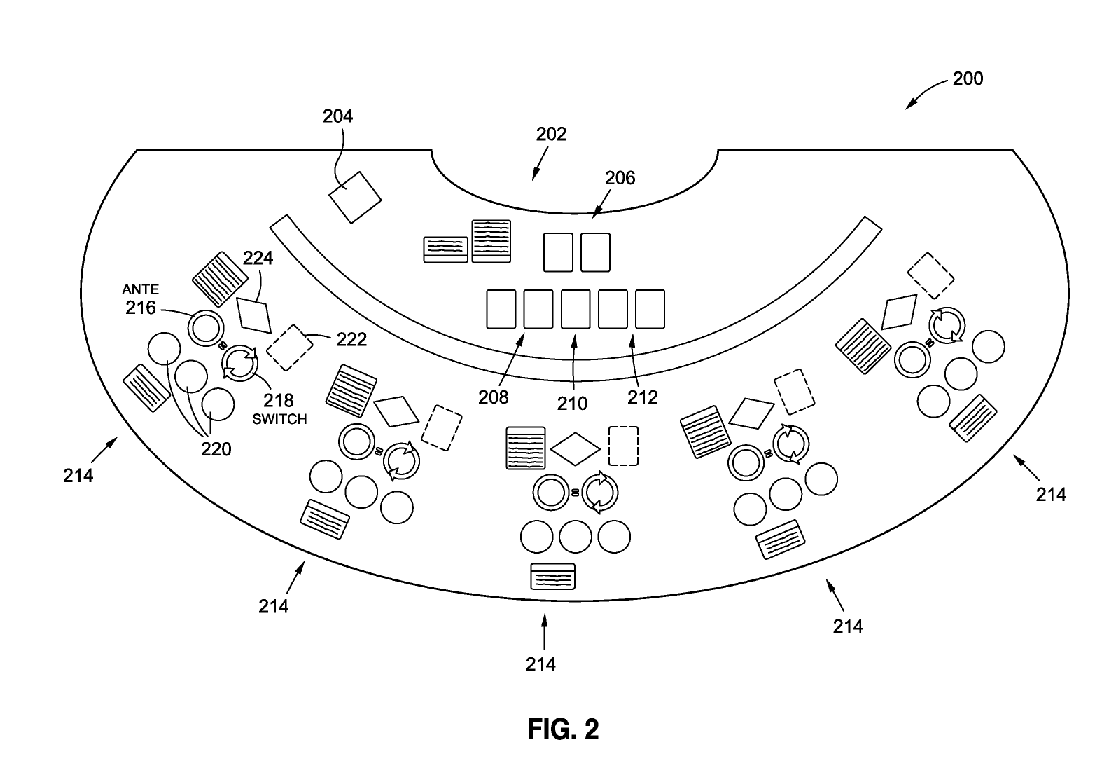

Games of the invention may also be implemented in various manners and formats. For example, as illustrated in FIG. 2, games of the invention may be implemented in a “table” format. In such a configuration, the game may be presented at a gaming table using physical playing cards.

As illustrated in FIG. 2, a game playing surface, such as a gaming table 200 or board is provided. The gaming table 200 (or a surface thereof, such as a “gaming felt” or other covering which is applied to the surface, printing on the gaming table or the like) may include or define a dealer station 202 where a dealer may run a game as described above. The dealer station 202 may include dealer controls to administer the game, an automatic card shuffler and/or card shoe 204, and the like.

The table 200 also includes or defines one or more player stations 214. In one embodiment, each player station 214 comprises an area or portion of the table or its play surface.

In one embodiment, the table 200 defines one or more game play features. Such features may be defined by printing on the table or its covering surface, by one or more displays and/or by surface or topographical features such as depressed areas, raised areas, contours or the like.

In one embodiment, the dealer station 202 defines a dealer hole card area 206, a flop card area 208, a first turn card area 210 and a second turn card area 212. These areas may be defined by printing or the like, as detailed above.

Each player station 214 preferably defines an ante wager area 216, a switch bet area 218, at least one additional wager area 220, and a player switch card area 222 (such as defining a location at which the player may surrender their initial hole cards), and a bonus bet area 224. These areas may be defined by printing or the like, as detailed above.

Of course, the table may include other areas or information, such as other card areas, pay tables, instructions and the like.

The player stations 214 might also or alternatively include a number of electronic controls for placing wagers, indicating a desire to card switch, or otherwise designate game play decisions to the dealer. The wagering areas 216, 218, 220 may be configured to automatically detect a wager via RFID, NFC, or other similar means, such as by detecting the placement of one or more RFID tagged wagering chips in those areas. Alternatively, one or more of the wagering areas might comprise a slot or the like into which a chip, coin, etc. may be inserted.

The gaming table 200 may optionally include one or more displays, such as electronic video displays. The displays may show game information to the players, such as a payout table, a status of bets and wagers, etc. There may also be a camera (not shown) disposed above the table. The camera may output images to the display so that the players and other onlooker may easily watch the game as it progresses. In another embodiment, the player and/or dealers areas might include one or more electronic displays for displaying game information electronically (images of cards, etc.). The displays might also include a touch screen or be associated with other input devices (buttons, keypad, etc.) for receiving wager information from a player, etc.

The size of the gaming board or table 200 may vary, as may its shape, etc. The top or playing surface of the gaming table 200 may preferably be elevated, such as by legs, etc.

Relative to a gaming table 200 such as that in FIG. 2, a player desiring to play the game preferably places an ante wager, such as by placing one or more chips at the ante wager area 216, and places a switch bet, such as by placing one or more chips at the switch bet area 218. The dealer preferably deals two hole cards, such as to a player's hole card area and two cards to the dealer's hole card area 206.

Of course, wagers might be placed in manners other than by using/placing monetary value chips. Wagers might be placed using coins, currency, or electronically, such as via electronic credits or monetary value, such as associated with an account or balance of credits/monies.

The game is preferably played using one or more standard decks of 52 physical cards comprising the cards 2, 3, 4, 5, 6, 7, 8, 9, 10, J, Q, K and Ace in each of the suits of Hearts, Diamonds, Spades and Clubs, wherein the suit and rank of each card is displayed on a first side of the card and the opposite side of the card defines a card back which does not display the card suit and rank.

In one embodiment, the cards may be dealt from a shuffled deck or a shoe of multiple cards. The cards may also be dealt or provided by an automatic card shuffling device. Of course, the game might be played with other sets or types of cards, such as one or more decks of cards with one or more wildcards or Jokers or other types of cards.

Preferably, at least the dealer's hole cards are dealt face-down so that the player cannot see the rank and suit of the dealer's hole cards.

The player then elects to whether to switch hole cards. If so, such as by the player placing their original hole cards in the switch card area 222, the dealer preferably collects the player's original hole cards and deals two new or replacement hole cards, such as to a player's hole card area. The dealer also preferably collects the player's switch bet from the switch bet area 218.

Thereafter, the player may place a first additional wager in the additional wager area(s) 220. The dealer then deals the flop card, face up, to the flop card area 208. The game continues above with the player placing any additional wagers in the additional wager area(s) 220 and the dealer dealing a first turn card to the first turn card area 210 and the remaining turn cards to the second turn card area 212.

If the dealer wins the game, the dealer preferably collects all of the player's wagers from the wagering areas (including the switch bet, if not already collected). If the player wins, the player is preferably awarding wins as described above, such as by the dealer awarding the player additional chips, etc.

In another embodiment, the methods of game play and presentation are implemented via a gaming machine or device. Such a gaming machine may have various configurations.

The gaming machine may be located at a casino (and as such may be referred to as a “casino gaming machine”). As described below, the gaming machine may be part of a gaming system, such as a casino gaming system which links two or more of the gaming machines or one or more gaming machines with other devices, such as one or more table games, kiosks, accounting systems or servers, progressive systems or servers, player tracking systems or servers or the like.

One configuration of a gaming machine 322 of the invention is illustrated in FIG. 1. As illustrated, the gaming machine 322 generally comprises a housing or cabinet 326 for supporting and/or enclosing various components required for operation of the gaming machine. In the embodiment illustrated, the housing 326 includes a door located at a front thereof, the door capable of being moved between an open position which allows access to the interior, and a closed position in which access to the interior is generally prevented. The configuration of the gaming machine 322 may vary. In the embodiment illustrated, the gaming machine 322 has an “upright” configuration. However, the gaming machine 322 could have other configurations, shapes or dimensions (such as being of a “slant”-type, “bar-top” or other configuration as is well known to those of skill in the art).

The gaming machine 322 preferably includes at least one display device 328 configured to display game information. The display device 328 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 328 may be capable of projecting or displaying a wide variety of information, including images, symbols and other indicia or information associated with game play, game promotion or other events. The gaming machine 322 might include more than one display device 328, such as two or more displays 328 which are associated with the housing 326. The gaming machine 322 might also include a top box or other portion. Such a top box might include one or more display devices 328, such as in addition to one or more main displays which are associated with the housing 326. Also, the gaming machine 322 might include side displays (such as mounted to the exterior of the housing 326) and might include multiple displays of differing sizes.

As described in more detail below, the gaming machine 322 is preferably configured to present one or more games upon a player making a monetary payment or wager. In this regard, as described in more detail below, the gaming machine 322 includes means for accepting monetary value.

In one embodiment, as detailed above, certain game outcomes may be designated as winning outcomes. Prizes or awards may be provided for winning outcomes, such as monetary payments (or representations thereof, such as prize of credits), or promotional awards as detailed herein. As detailed below, the gaming machine 322 includes means for returning unused monetary funds and/or dispensing winnings to a player.

The gaming machine 322 preferably includes one or more player input devices 330 (such as input buttons, plunger mechanisms, a touch-screen display, joystick, touch-pad or the like). These one or more devices 330 may be utilized by the player to facilitate game play, such as by providing input or instruction to the gaming machine 322. For example, such input devices 330 may be utilized by a player to place a wager, cause the gaming machine 22 to initiate a game, to indicate cards to be held or discarded, to “cash out” of the gaming machine, or to provide various other inputs.

In one preferred embodiment, the gaming machine 322 includes at least one microprocessor or controller for controlling the gaming machine, including receiving player input and sending output signals for controlling the various components of the machine 322 (such as generating game information for display by the display 328). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display 328 (such as information comprising dealt cards, as detailed below), for determining winning or losing game outcomes and for displaying information regarding awards for winning game outcomes, among other things.

The controller may be configured to execute machine readable code or “software” or otherwise process information, such as obtained from a remote server. Software or other instructions may be stored on a memory or data storage device. The memory may also store other information, such as pay table information. The gaming machine 322 may also include one or more random number generators for generating random numbers, such as for use in selecting playing cards and for presenting the game in a random fashion (e.g. whereby the game is presented in a manner in which the player cannot control the outcome).

Preferably, the controller is configured to execute machine readable code or instructions which are configured to implement the method of game play of the invention. For example, the controller of the gaming machine 322 may be configured to detect a wager, such as a signal from a player's depressing of the “bet one” button. Upon such an event and/or the player otherwise signaling the gaming machine to present the game, the controller may be configured to cause game symbols or other game information to be displayed on the at least one display 328. The controller may accept input from a player of game inputs, such as a request to spin reels or the like, via the one or more player input devices of the gaming machine 322.

The gaming machine 322 may be configured to generate and present games in a stand-alone manner or it may be in communication with one or more external devices at one or more times. For example, the gaming machine 322 may be configured as a server based device and obtain game code or game outcome information from a remote game server (in which event the gaming machine controller may receive game information from the server, such as game outcome information, and use that server-generated information to present the game at the gaming machine).

As indicated, the gaming machine 322 is configured to present one or more wagering games. Thus, the gaming machines 322 is preferably configured to accept value, such as in the form of coins, tokens, paper currency or other elements or devices representing value such as monetary funds. For example, as illustrated in FIG. 1, the gaming machine 322 might include a coin acceptor 332 for accepting coins. Of course, associated coin reading/verifying devices and coin storage devices may be associated with the gaming machine 322 if it is configured to accept coins. Likewise, the gaming machine 322 might include a media reader 334. Such a reader may be configured to accept and read/verify paper currency and/or other media such as tickets. Of course, in such event the gaming machine 322 may further be configured with one or more paper currency or ticket storage devices, such as cash boxes, and other paper currency or media handling devices (including transport devices).

The gaming machine 322 might also be configured to read FOBs, magnetic stripe cards or other media having data associated therewith and via which value or funds may be associated with the gaming machine 322.

In one embodiment, the gaming machine 322 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. For example, upon an award or at cash-out, associated funds may be paid to the player by the gaming machine 322 dispensing coins to a coin tray. In another embodiment, funds may be issued by dispensing paper currency. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,269 to Burns, which is incorporated herein in its entirety by reference.

The gaming machine 322 may also include a player tracking device, such as a card reader 366 and associated keypad 370. Such player tracking devices are well known and may permit the game operator to track play of players of the gaming machine. The tracked play may be utilized to offer player bonuses or awards.

A casino may have numerous such gaming machines 322, such as located on a casino floor or in other locations. Of course, such gaming machines 322 might be used in other environments, such as an airport, a bar or tavern or other locations.

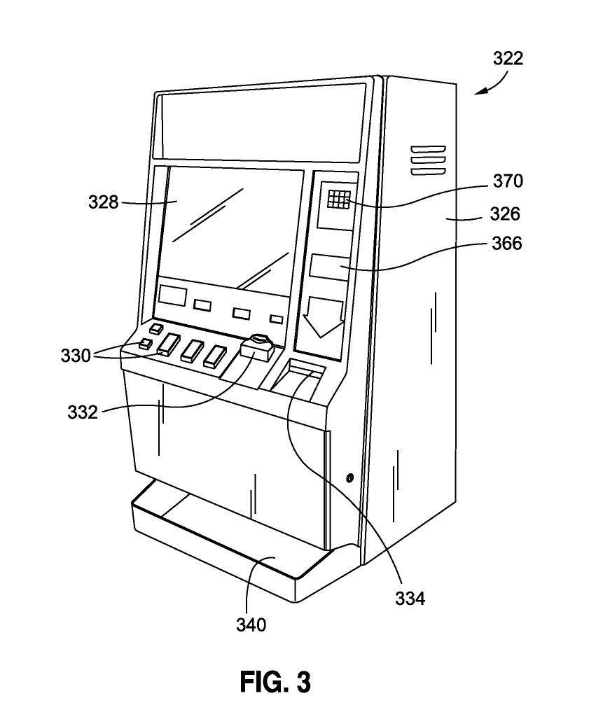

It will be appreciated that the gaming machine illustrated in FIG. 3 is only exemplary of one embodiment of a gaming machine. For example, it is possible to for the gaming machine to have various other configurations, including different shapes and styles and having different components than as just described.

For example, instead of comprising a “casino”-style gaming machine, it is possible for the game of the invention to be presented on a computing device, including at a home or office computer or a player's mobile electronic device such as a PDA, phone or the like. In one embodiment, a player might log in to a casino server and the controller of the casino server may cause game information to be delivered to the player's computer via a communication link and then be displayed on a display of the player's computer. The communication link might comprise or include the Internet, a casino network such as a wired or wireless LAN, or combinations of public and/or private networks including wired and/or wireless links. In such a configuration it will be noted that the term “controller” may comprise more than one device. For example, in a server-based environment, a controller at a server may generate game information and transmit that information to a local controller at a gaming machine or a player's computer or other electronic device. The local controller at the gaming machine or the player's computer or other electronic device may then cause game information to be displayed on one or more associated displays.

Relative to a gaming machine 322 described above, a player may associate funds or credits with the machine 322 for wagering. The player may place an electronic ante wager and switch bet, such as by one or more input devices to the gaming machine 322 and/or by starting a game. The player's hole cards are preferably displayed electronically on the display 328, along with the flop and turn cards. The dealer's cards may be shown graphically in a face down position or may not be shown. Winnings for a winning game outcome may be paid or awarded in the form of electronic credits or the like, as described above.

In this configuration, the player effectively plays against an electronic dealer or the house. It is possible for the game to comprise a multi-player game, such as in an environment in which two or more gaming machines are linked or in an online game play environment.

A particular advantage of the invention is a card game in which an initial set of cards are dealt to the player with the player being given a switch opportunity. Most importantly, however, a unique switch bet is required, which switch bet is unique to the card switch feature and its relationship to the game overall (including how/when it is collected and how it is paid, wherein the switch bet is preferably a push or lose bet and does not result in the award of winnings).

Other aspects of the invention comprise a unique combination of dealt cards and wagering opportunities.

It will be appreciated that the switch bet feature might be applied to other game variations. For example, other configurations of wagers might be permitted, such as wagers of different amounts, or greater or fewer wagering opportunities.

In one embodiment, there might be differing numbers of flop and/or turn cards and/or their order of dealing might vary. In the embodiment described, the game is played as a poker type game in which the player plays with two hold cards and two flop and three turn cards are dealt as community cards which the player can use in combination with their hole cards. However, as another example, one flop card might be provided but four turn cards might be provided. In another example, two first turn cards might be dealt and then a single second turn card might be dealt. In one embodiment, the player receives two hole cards and uses those cards in combination with five community cards to form a five card hand. However, other numbers of cards might be used/dealt.

The game may be played with other options or variations. For example, in a preferred embodiment, the dealer's hand need not qualify in order to be compared to the player's hand. However, in some embodiments the dealer's hand might be required to qualify (and if it does not, the player might be awarded winnings or any wagers might simply be returned to the player). The game might also be played with a side bet option, such as a side bet played against a pay table of outcomes and winnings that the player's final hand will comprise a hand of a predetermined rank.

In one embodiment, the game may be played with one or more side or bonus bets or wagers. For example, in one embodiment a player make a bonus bet at the beginning of the game (such as before any cards are dealt) that the player's final hand will comprise a predetermined hand. The bonus wager might provide for a pay table of predetermined winning hands having associated winnings. For example, relative to a game in which the player attempts to form a best five card poker hand, the bonus wager might comprise a wager that the player's final hand is a poker hand of a predetermined rank. As illustrated in FIG. 2, a player might place their bonus wager in the bonus wager area 222. If the player's final hand does not comprise a winning hand, the player preferably loses that wager. If the player's final hand is a winning hand, the player is preferably paid winnings, such as based upon a pay table.

In a preferred embodiment, the player can win the bonus wager even if they do not win their ante or main wagers (e.g. the player's hand does not beat the dealer). For example, the player might win the bonus wager by having a final Full House hand, even though that hand did not beat the dealer's hand of a Straight. As another example, the player might fold after placing the ante and initial wagers and thus lose those wagers. However, the player's initial hole cards in combination with the five community cards might still form a winning bonus wager hand and thus the player might still win the bonus wager.

It will be understood that the above described arrangements of apparatus and the method there from are merely illustrative of applications of the principles of this invention and many other embodiments and modifications may be made without departing from the spirit and scope of the invention as defined in the claims.

1. A method of playing a card game at a gaming table comprising the steps of:
receiving an ante wager from a player at an ante wager area of said gaming table;
receiving a switch bet from said player at a switch bet area of said gaming table;
dealing one or more original hole cards to said player, said cards comprising physical playing cards dealt from at least one deck of cards;
receiving an election from said player whether to switch said one or more hole cards, wherein if said player elects, dealing a replacement hole card to said player for each original hole card, each replacement hole card comprising a physical card dealt from said at least one deck of cards and collecting said player's switch bet;
dealing one or more flop cards and one or more turn cards, said one or more flop cards and one or more turn cards comprising physical playing cards dealt from said at least one deck of cards;
receiving one or more additional wagers from said player at an additional wager area of said gaming table;
determining an outcome of said game by comparing a dealer hand to a final player hand formed from said one or more replacement or hole cards and said one or more flop cards and said one or more turn cards; and
if said outcome of said game is a dealer hand win, collecting said player's ante wager, any additional wagers and said switch bet if not already collected;
if said outcome of said game is a player hand win, awarding said player winnings and, if said player's switch bet was not collected, returning said switch bet to said player.

2. The method in accordance with claim 1 further comprising the step of dealing one or more hole cards to said dealer, said hole cards comprising physical cards dealt from said at least one deck of cards.

3. The method in accordance with claim 1 wherein said one or more original hole cards are dealt to a hole card area of said gaming table.

4. The method in accordance with claim 1 wherein said step of receiving an ante wager comprises receiving at least one wagering chip at said ante wagering area.

5. The method in accordance with claim 1 wherein said step of receiving a switch bet comprises receiving at least one wagering chip at said switch bet area.

6. The method in accordance with claim 1 wherein said step of dealing one or more original hole cards comprises dealing two hole cards.

7. The method in accordance with claim 1 wherein said step of dealing one or more flop cards comprises dealing two flop cards.

8. The method in accordance with claim 1 wherein said step of dealing one or more turn cards comprises dealing a first turn card and two second turn cards.

9. The method in accordance with claim 1 comprising dealing two hole cards, two flop cards and three turn cards.

10. The method in accordance with claim 1 wherein said one or more flop cards and said one or more turn cards are dealt as community cards.

11. The method in accordance with claim 1 wherein said step of receiving one or more additional wagers comprises receiving a first additional wager before said one or more flop cards are dealt and one or more second additional wagers after said one or more flop cards are dealt and before said one or more turn cards are dealt.

12. The method in accordance with claim 1 wherein said dealer hand comprise a five card poker hand and said final player hand comprises a five card poker hand.

13. The method in accordance with claim 1 wherein said ante wager and said switch bet are of the same value.

14. The method in accordance with claim 1 wherein said step of awarding winnings comprises awarding winnings in the amount of the value of said ante wager and any additional wagers placed by said player.

15. An electronic gaming machine comprising:
at least one display device;
at least one input device;
a wager accepting device configured to accept a physical item associated with a monetary value to fund wagering activity at the electronic gaming machine;
a processor; and
a memory storing machine readable code, which when executed by the processor, causes the electronic gaming machine to:
receive an ante wager from a player via the at least one input device;
receive a switch bet from said player via the at least one input device;
deal one or more original hole cards to said player from at least one deck of cards and display said one or more original hold cards on the at least one display device;
receive an election from said player whether to switch said one or more hole cards, wherein if said player elects, dealing a replacement hole card to said player for each original hole card, each replacement hole card comprising a card dealt from said at least one deck of cards, displaying each replacement hole card on the at least on display device, and collecting said player's switch bet;
deal one or more flop cards and one or more turn cards, said one or more flop cards and one or more turn cards being dealt from said at least one deck of cards and being displayed on the at least one display device;
receive one or more additional wagers from said player via said at least one input device;
determine an outcome of said game based on a final player hand formed from said one or more replacement or hole cards and said one or more flop cards and said one or more turn cards;
if said outcome of said game is a losing outcome, collect said player's ante wager, any additional wagers, and said switch bet if not already collected; and
if said outcome of said game is a winning outcome, award said player winnings and, if said player's switch bet was not collected, return said switch bet to said player.

16. The electronic gaming machine of claim 15 wherein a number of the hole cards dealt is two.

17. The electronic gaming machine of claim 15 wherein a number of the flop cards dealt is two.

18. The electronic gaming machine of claim 15 wherein said one or more turn cards comprises a first turn card and two second turn cards.

19. The electronic gaming machine of claim 15 wherein the one or more original hole cards comprises two hole cards, the one or more flop cards comprises two flop cards, and the one or more turn cards comprises three turn cards.

20. The electronic gaming machine of claim 15 wherein said one or more flop cards and said one or more turn cards are dealt as community cards.
